(19) United States
(12) Patent Application Publication
(10) Pub. No.: US 2024/0228276 A1
(43) Pub. Date: Jul. 11, 2024

(54) HYDROGEN PRODUCTION FROM PYROLYSIS OF BIOMASS AT A TEMPERATURE OF AT LEAST 950°C

(71) Applicant: Abundia Biomass-to-Liquids Limited, Redcar (GB)

(72) Inventor: Martin Atkins, Redcar (GB)

(21) Appl. No.: 18/557,884

(22) PCT Filed: Apr. 28, 2022
(86) PCT No.: PCT/GB2022/051087

§ 371 Date: Oct. 27, 2023

(30) Foreign Application Priority Data
Apr. 28, 2021 (GB) 2106088.4

(51) Int. Cl. C01B 3/50; C01B 3/16; C10B 53/02; C10B 57/16

(52) U.S. Cl. CPC C01B 3/503; C01B 3/16; C10B 53/02; C10B 57/16

(57) ABSTRACT

The present invention relates to a process for forming a bio-derived hydrogen gas from a biomass feedstock, and the bio-derived hydrogen gas formed therefrom. The present invention also relates to the use of a bio-derived hydrogen gas in fuel cells, petroleum refining and in forming bio-derived ammonia and methane.

### FIELD OF INVENTION

The present invention relates to a process for forming a bio-derived hydrogen gas from a biomass feedstock, and the bio-derived hydrogen gas formed therefrom. The present invention also relates to the use of a bio-derived hydrogen gas in fuel cells, petroleum refining and in forming bio-derived ammonia and methane.

### BACKGROUND

Demand for energy has increased over the years due to greater dependence on technology both in a personal and commercial capacity, expanding global population and the required technological progress made in developing countries. Energy resources have traditionally been derived primarily from fossil fuels however, as supply of such resources declines, a greater significance is placed on research looking at alternative methods of providing energy. Further, increased awareness of the environmental impact of burning fossil fuels and commitments to reducing the emission of greenhouse gases has significantly increased the demand for greener energy resources.

Hydrogen gas is considered to be a viable, more environmentally friendly energy source for use in buildings, industry and transport, and so research into alternative means of producing hydrogen gas and its use in place of traditional fossil fuel-based energy has significantly increased in recent times. Whilst hydrogen is the most abundant element on earth, it readily reacts with other chemical elements and therefore forms compounds, such as water, hydrocarbons, natural biomass and alcohols. Accordingly, hydrogen gas is a secondary form of energy in that it must be manufactured.

It is known that hydrogen fuel can be produced using a variety of processes, including thermal techniques (such as natural gas reforming, renewable liquid and bio-oil processing, biomass, and coal gasification), electrolysis (water splitting using a variety of energy resources), and photolysis (splitting of water using sunlight through biological and electrochemical processes).

Currently, the most common method of producing hydrogen gas is through thermal processing of non-renewable resources, using either (i) steam reforming processes, (ii) partial oxidation processes, or (iii) autothermal reforming.

Steam reforming is the most widely used thermal processing technique due its efficiency and the economic benefits of this process. Non-renewable starting materials for use in generating hydrogen gas include natural gas and lighter hydrocarbons, methanol and other oxygenated hydrocarbons. The steam reforming process comprises two stages. In the first stage, the hydrocarbon raw material is mixed with high temperature steam (approximately 700° C. to 1,000° C.) in a catalytic reactor, wherein the reactor provides sufficient heat (around 500 to 900° C.) for the endothermic reaction to proceed. Suitable catalysts for use in steam reforming reactions include Ni/MgO, Pt/ZrO₂ and Ir/ZrO₂. A mixture of hydrogen and carbon monoxide (also referred to as syngas) is formed (as shown in Equation 1 below) along with small amounts of carbon dioxide.

CH₄+H₂O(+heat)→CO+3H₂ (1)

The gas produced in the first stage is cooled to around 350° C. In order to increase the amount of hydrogen produced, the carbon monoxide formed is then converted to carbon dioxide and hydrogen via a water-gas shift reaction (as shown in Equation 2), in a second stage.

CO+H₂O→CO₂+H₂ (2)

As can be seen from the equations above, as a result of the steam reforming process, carbon dioxide is produced. In some steam reforming methods, no steps are taken to capture the greenhouse gases formed. In this case, the hydrogen gas produced is referred to as “grey” hydrogen. In processes where greenhouse gases are at least partially captured and stored underground the hydrogen produced is referred to as “blue” hydrogen. However, even where steps are included which actively aim to prevent greenhouse gases from entering the atmosphere, around 10 to 20% of carbon dioxide produced cannot be captured.

Furthermore, due to the use of natural gas as a raw material in steam reforming, it is necessary to include a desulphurisation pre-treatment step in order to avoid deactivation of the catalysts used. However, any remaining sulphur may still be oxidised and can further react with water to produce sulphuric acid (H₂SO₄). Sulphuric acid formed can condense on metal surfaces of, for example, combustion engines, causing corrosion.

Whilst steam reforming process are commonly used due to low production costs, such processes still depend on non-renewable fossil fuels, and so it would be beneficial to provide alternative, more sustainable processes of generating hydrogen gas. Furthermore, although hydrogen gas itself is considered a green fuel, its production based on fossil fuel raw materials can lead the formation of significant amounts of greenhouse gases, for example, steam reforming can generate as much carbon dioxide as the direct combustion of the fossil fuel itself.

Partial oxidation and catalytic partial oxidation of hydrocarbons can be used to produce hydrogen gas for automobile fuel cells. The hydrocarbons used in such processes are primarily heavy oil fractions which again, include sulphur-containing compounds. Partial oxidation is a non-catalytic process, in which the raw material is gasified in the presence of oxygen and possibly steam. In the absence of a catalysts, higher temperatures (around 1,300 to 1,500° C.) and pressures (between 3 and 8 MPa) are required. An example of a partial oxidation reaction is provided in reaction Equation 3 below.

$${CH}_{4} + \frac{1}{2} {O}_{2} \to CO + 2 {O}_{2} \qquad ( 3 )$$

In the above reaction, acetylene is formed as an intermediate product, the decomposition of acetylene can lead to soot formation, which is clearly undesirable. Soot can be harmful to human health, for example when inhaled soot can lead to heart attacks, bronchitis, aggravated asthma, strokes, and even premature death. The generation of soot can also produce unfavourable environmental effects, for example sulphur dioxides and nitrogen oxides present in soot can react with moisture present in the air to form acid rain.

Further, as partial oxidation reactions do not require the presence of a catalyst, desulphurisation pre-treatment steps are not required, and thus hydrogen sulphide, a highly corrosive and poisonous gas, and carbon oxysulfide, a greenhouse gas, can be formed. Additional greenhouse gases produced include methane and carbon dioxide.

Both partial oxidation and catalytic partial oxidation reactions, again, produce significant amounts of carbon monoxide. Accordingly, further processing steps, such as converting carbon monoxide to carbon dioxide and hydrogen via a water-gas shift reaction are often applied. As discussed above, such process steps further increase the amount of greenhouse gases generated.

In order to overcome at least some of the issues associated with producing hydrogen gas from non-renewable, fossil fuel sources, research within this field has focussed on the production of hydrogen gas as a by-product in the formation of bio-fuels.

Bio-fuels are considered to be a promising, more environmentally-friendly alternative to fossil fuels, in particular, diesel, naphtha, gasoline and jet fuel. The term biomass is commonly used with respect to materials formed from plant-based sources, such as corn, soy beans, flaxseed, rapeseed, sugar cane, and palm oil, however this term encompasses materials formed from any recently living organisms, or their metabolic by-products. Biomass materials comprise lower amounts of nitrogen and sulphur compared to fossil fuels and produce no net increase in atmospheric CO₂ levels, and so the formation of an economically viable hydrogen gas by-product would be environmentally beneficial.

Thermo-conversion methods are currently considered to be the most promising technology in the conversion of biomass to bio-fuels. Thermo-chemical conversion includes the use of pyrolysis, gasification, liquefaction and supercritical fluid extraction. In particular, research has focussed on pyrolysis and gasification for forming bio-fuels.

Gasification comprises the steps of heating biomass materials to temperatures of over 430° C. in the presence of oxygen or air in order to form carbon monoxide and hydrogen (also referred to as synthesis gas or syngas). In forming biofuels, syngas can then be converted into liquid fuel using a catalysed Fischer-Tropsch synthesis. The Fischer-Tropsch reaction is usually catalytic and pressurised, operating at between 150 and 300° C. The catalyst used requires clean syngas and so additional steps of syngas cleaning are also required.

A typical gasification method comprising a biomass material produces a H₂:CO ratio of around 1, as shown in Equation 4 below:

C₆H₁₀O₅+H₂O=6CO+6H₂ (4)

Accordingly, the reaction products are not formed in the ratio of CO to H₂ required for the subsequent Fischer-Tropsch synthesis to form bio-fuels (H₂:CO ratio of ˜2). In order to increase the ratio of H₂ to CO, the following additional steps are commonly applied:
An additional water gas shift reaction is used;
Hydrogen gas is added;
Carbon is extracted using gasification;
Increased amounts of CO₂ are produced by using excess steam: C₆H₁₀O₅+7H₂O=6CO₂+12H₂. Carbon dioxide can be converted to carbon monoxide through the addition of carbon, referred to as gasification with carbon dioxide, instead of steam.
Unreacted CO is removed and used for forming of heat and/or power.

Overall, the gasification reaction requires multiple reaction steps and additional reactants, and so the energy efficiency of producing a biofuel in this manner is low. Furthermore, the increased time, energy requirements, reactants and catalysts required to combine gasification and Fischer-Tropsch reactions greatly increases manufacturing costs. As discussed above, the relative amounts of hydrogen gas produced by such processes is typically lower than that required to produce bio-fuels and so it is not considered feasible that such processes could also be used as a hydrogen gas source.

Of the thermo-conversion processes, pyrolysis methods are considered to be the most efficient pathway to convert biomass into a bio-derived oil. Pyrolysis methods produce bio-oil, char and non-condensable gases (including hydrogen gas) by rapidly heating biomass materials in the absence of oxygen. The ratio of products produced is dependent on the reaction temperature, reaction pressure and the residence time of the pyrolysis vapours formed.

Higher amounts of biochar are formed at lower reaction temperatures and lower heating rates; higher amounts of liquid fuel are formed using lower reaction temperatures, higher heating rates and shorter residence times; and fuel gases are preferentially formed at higher reaction temperatures, lower heating rates and longer residence times. Pyrolysis reactions are split into three main categories, conventional, fast and flash pyrolysis, depending on the reaction conditions used.

In a conventional pyrolysis process the heating rate is kept low (around 5 to 7° C./min) heating the biomass up to temperatures of around 275 to 675° C. with residence times of between 7 and 10 minutes. The slower increase in heating typically results in higher amounts of char being formed compared to bio-oil and gases.

Fast pyrolysis comprises the use of high reaction temperatures (between 575 and 975° C.) and high heating rates (around 300 to 550° C./min) and shorter residence times of the pyrolysis vapour (typically up to 10 seconds) followed by rapid cooling. Fast pyrolysis methods increase the relative amounts of bio-oil formed.

Flash pyrolysis comprises rapid devolitalisation in an inert atmosphere, a high heating rate, high reaction temperatures (typically greater than 775° C.) and very short vapour residence times (<1 second). In order for heat to be sufficiently transferred to the biomass materials in these limited time periods, the biomass materials are required to be present in particulate form with diameters of about 1 mm being common. The reaction products formed are predominantly gas fuel.

However, bio-oils produced through a pyrolysis process often comprise a complex mixture of water and various organic compounds, including acids, alcohols, ketones, aldehydes, phenols, esters, sugars, furans, and hydrocarbons, as well as larger oligomers. The presence of water, acids, aldehydes and oligomers are considered to be responsible for poor fuel properties in the bio-oil formed.

Furthermore, the resulting bio-oil can contain 300 to 400 different oxygenated compounds, which can be corrosive, thermally and chemically unstable and immiscible with petroleum fuels. The presence of these oxygenated compounds also increases the viscosity of the fuels and increases moisture absorption.

In order to address these issues, several upgrading techniques have been proposed, including catalytic (hydro)deoxygenation using hydro-treating catalysts, supported metallic materials, and most recently transition metals. However, catalyst deactivation (via coking) and/or inadequate product yields means that further research is required.

Alternative upgrading techniques include emulsification catalytic hydrogenation, fluidised catalysed cracking and/or catalytic esterification. However, as previously known methods of producing a bio-derived hydrocarbon feedstock result in a wide range of hydrocarbon compounds, including significant amounts of contaminants and/or undesirable components, the bio-derived hydrocarbon feedstock may not be sufficiently stable to undergo upgrading cracking processes, such as fluid catalysed cracking, and can repolymerise blocking or reducing the flow within such reactor systems. Inevitably, the need for additional refinement steps and additional reactant materials increases both the time and cost associated with such processes both in terms of operating costs and capital expenditure.

Whilst the production of hydrogen gas from biomass materials has several environmental advantages compared to the use of fossil fuels, the cost of forming bio-derived hydrogen gas is significantly higher, thus limiting commercial exploitation. Accordingly, there is a need in the art for more costs effective processes of producing bio-derived hydrogen fuels.

In particular, it would be desirable to provide a more cost-effective method of producing bio-derived fuels, comparable to hydrogen gas produced from fossil fuel resources.

### DESCRIPTION OF THE INVENTION

In a first embodiment, the present invention relates to a process for forming a bio-derived hydrogen gas from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the non-condensable light gases from the mixture formed in step c.; and
e. separating hydrogen gas from the remaining non-condensable light gases using a hydrogen separation membrane.

Preferably, the biomass feedstock comprises cellulose, hemicellulose or a lignin-based feedstock.

Whilst it is possible to use food crops, such as corn, sugar cane and vegetable oil as a source of biomass, it has been suggested that the use of such starting materials can lead to other environmental and/or humanitarian issues. For example, where food crops are used as a biomass source, more land must be dedicated to growing the additional crops required or a portion of the crops currently grown must be diverted for this use, leading to further deforestation or an increase in the cost of certain foods. Accordingly, the biomass feedstock is preferably selected from a non-crop biomass feedstock.

In particular, it has been found that suitable biomass feedstocks may be preferably selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

During combustion of a hydrocarbon feedstock or a bio-fuel, sulphur contained therein may be oxidised and can further react with water to produce sulphuric acid (H₂SO₄). The sulphuric acid formed can condense on the metal surfaces of combustion engines causing corrosion. Thus, further or repeated processing steps are required to reduce the sulphur content of bio-fuels to a suitable level. This in turn increases the processing time to produce a viable bio-fuel and increases the cost associated with manufacturing these materials. Accordingly, the biomass feedstock can be selected from a low sulphur biomass feedstock. In general, non-crop biomass feedstocks contain low amounts of sulphur, however particularly preferred low sulphur biomass feedstocks include miscanthus, grass, and straw, such as rice straw or wheat straw.

The use of a low sulphur biomass feedstock reduces the extent to which the resulting hydrocarbon feedstock and non-condensable gases will be required to undergo desulphurisation processing in order to meet industry requirements, in some cases the need for a desulphurisation processing step is eliminated.

During the pyrolysis step, the efficiency of heat transfer through the biomass material has been found to be at least partially dependent on the surface area and volume of the biomass material used. Thus, preferably, the biomass feedstock is ground in order break up the biomass material and/or to reduce its particle size, for example through the use of a tube grinder, a mill, such as a hammer mill, knife mill, slurry milling, or resized through the use of a chipper, to the required particle size. Preferably, the biomass feedstock is provided in the form of pellets, chips, particulates or a powder. More preferably, the pellets, chips, particulates or powders have a diameter of from 5 μm to 10 cm, such as from 5 μm to 25 mm, preferably from 50 μm to 18 mm, more preferably from 100 μm to 10 mm. These sizes have been found to be particularly useful with respect to efficient heat transfer. The diameter of the pellets, chips, particulates and powders defined herein relate to the largest measurable width of the material.

It has also been found that, at high temperatures, such as those required during the high-temperature pyrolysis reaction, the presence of smaller particles can result in an increased chance of dust explosions and fires. However, it has been found that by at least partially removing or preventing the formation of biomass pellets, chips, particles or powders with a diameter of less than about 1 mm, the likelihood of dust explosions or fire occurring is significantly reduced. Accordingly, it is preferable for the biomass feedstock (generally in the form of pellets, chips, particulates or powder) to have a diameter of at least 1 mm, such as from 1 mm to 25 mm, 1 mm to 18 mm or 1 mm to 10 mm. The biomass feedstock may comprise surface moisture. Preferably, such moisture is reduced prior to the step of pyrolysing the biomass feedstock. The amount of moisture present in the biomass feedstock will vary depending on the type of biomass material, transport and storage conditions of the material before use. For example, fresh wood can contain around 50 to 60% moisture. The presence of increased amounts of moisture in the biomass feedstock has been found to reduce the efficiency of the pyrolysis step of the present invention as heat is lost through evaporation of the moisture—rather than heating the biomass material itself, thereby reducing the temperature to which the biomass material is heated or increasing the time to heat the biomass material to the required temperature. This in turn affects the desired ratio of pyrolysis products formed in the hydrocarbon feedstock product.

By way of example, the initial moisture content of the biomass feedstock may be from 10% to 50% by weight of the biomass feedstock, such as from 15% to 45% by weight of the biomass feed stock, or for example from 20% to 30% by weight of the biomass feedstock.

Preferably, the moisture content of the biomass feedstock is reduced to 7% or less by weight, such as 5% or less by weight of the biomass feedstock.

Optionally, the moisture of the biomass feedstock is at least partially reduced before the biomass feedstock is ground.

Alternatively, the biomass feedstock may be formed into pellets, chips, particulates or a powder before the moisture content of the biomass feedstock is at least partially reduced to 10% or less by weight of the biomass feedstock, for example where the forming process is a “wet” process or wherein the removal of at least some moisture from the biomass feedstock may be achieved more efficiently by increasing the surface area of the biomass feedstock material.

The amount of moisture present may be reduced through the use of a vacuum oven, a rotary dryer, a flash dryer or a heat exchanger, such as a continuous belt dryer. Preferably, moisture is reduced through the use of indirect heating methods, such as an indirect heat belt dryer, an indirect heat fluidised bed or an indirect heat contact rotary steam-tube dryer.

Indirect heating methods have been found to improve the safety of the overall process as the heat can be transferred in the absence of air or oxygen thereby alleviating and/or reducing the occurrence of fires and/or dust explosions. Furthermore, such indirect heating methods have been found to provide more accurate temperature control which, in turn, allows for better control of the ratio of pyrolysis products formed in the hydrocarbon feedstock product. In preferred processes, the indirect heating method comprises an indirect heat contact rotary steam-tube dryer wherein water vapour is used as a heat carrier medium.

The low moisture biomass feedstock may be pyrolysed at a temperature of at least 1000° C., more preferably at least 1100° C., for example 1120° C., 1150° C., or 1200° C.

In general, the biomass feedstock may be heated by convection heating, microwave heating, electrical heating or supercritical heating. By way of example, the biomass feedstock may be heated through the use of microwave assisted heating, a heating jacket, a solid heat carrier, a tube furnace or an electric heater. Preferably, the heating source is a tube furnace. The tube furnace may be formed from any suitable material, for example a nickel metal alloy.

As noted above, the use of indirect heating of the pyrolysis chamber is preferred as it reduces and/or alleviates the likelihood of dust explosions or fires occurring.

Alternatively or in addition, a heating source is positioned within the pyrolysis reactor in order to directly heat the low moisture biomass feedstock. The heating source may be selected from an electric heating source, such as an electrical spiral heater. It has been found to be beneficial to use two or more electrical spiral heaters within the pyrolysis reactor. The use of multiple heaters can provide a more homogenous distribution of heat throughout the reactor ensuring a more uniform reaction temperature is applied to the low moisture biomass material.

It has been found to be beneficial for the biomass material from step b. to be transported continuously through the pyrolysis reactor. For example, the biomass material may be transported through the pyrolysis reactor using a conveyor, such as a screw conveyor or a rotary belt. Optionally, two or more conveyors can be used to continuously transport the biomass material through the pyrolysis reactor. A screw conveyor has been found to be particularly useful as the speed at which the biomass material is transported through the pyrolysis reactor, and therefore the residence time in the pyrolysis reactor, can be controlled by varying the pitch of the screw conveyor.

Alternatively or in addition, the residence time of the biomass material within the reactor can be varied by altering the width or diameter of the pyrolysis reactor through which the biomass material is conveyed.

The biomass material may be pyrolysed under atmospheric pressure (including essentially atmospheric conditions). Preferably, the biomass material is pyrolysed in an oxygen-depleted environment in order to avoid the formation of unwanted oxygenated compounds, more preferably the biomass material is pyrolysed in an inert atmosphere, for example the reactor is purged with an inert gas, such as nitrogen or argon prior to the pyrolysis step. The biomass material may be pyrolysed under atmospheric pressure (including essentially atmospheric conditions). Alternatively, the biomass material may be pyrolysed under a low pressure, such as from 850 to 1,000 Pa, preferably 900 to 950 Pa. The resulting pyrolysis gases can subsequently be separated by any known methods within this field, for example through condensation and distillation. The application of pressure, such as between 850 to 1,000 Pa, during the pyrolysis step and subsequent condensation and distillation of the pyrolysis gases formed has been found to be beneficial in separating the pyrolysis gases from any remaining solids formed during the pyrolysis reaction, such as biochar. Thus, means may be provided for applying the necessary vacuum pressure and/or removing pyrolysis gases formed.

In particular examples, the biomass material is conveyed in a counter-current direction to any pyrolysis gases formed, and any solid material, such as biochar formed as a result of the pyrolysis step, is removed separate to the pyrolysis gases formed. As the hot pyrolysis gases pass through the biomass material, heat is transferred from the pyrolysis gases to the biomass material resulting in at least a minor amount of low-temperature pyrolysis of the biomass material.

In addition, the pyrolysis gases are at least partially cleaned as dust and heavy carbons present in the gases are captured by the biomass material.

Where the pyrolysis step is performed under low pressure conditions, a vacuum may be applied so as to aid the flow of pyrolysis gases in a counter-current direction to the biomass material being conveyed through the pyrolysis reactor, and optionally the removal of the pyrolysis gases.

In some examples, the biomass feedstock from step b. is pyrolysed for a period of from 10 seconds to 2 hours, preferably, from 30 seconds to 1 hour, more preferably from 60 second to 30 minutes, such as 100 seconds to 10 minutes.

In accordance with the present invention, step d. may further comprise the step of first cooling the pyrolysis gases formed, for example through the use of a venturi, in order to condense the hydrocarbon feedstock product and subsequently separating from the liquid hydrocarbon feedstock product and non-condensable gases formed.

The non-condensable light gases may be separated from the hydrocarbon feedstock product through any known methods within this field, for example by means of flash distillation or fractional distillation.

In accordance with the present invention, hydrogen gas is at least partially separated from the remaining non-condensable light gases through the use of a hydrogen separation membrane. Any suitable hydrogen separation membrane known in this field may be used in accordance with the present invention; however the hydrogen separation membrane is preferably selected from a polymeric membrane, a metal organic framework (MOF) or a metallic membrane. In particular, the metallic membrane may comprise a single metal, a metal alloy and/or a metallic complex.

Permeability and selectivity are the two most important criteria for evaluating the performance of a hydrogen separation membrane, however there is always a trade-off between these two properties. Membranes having a higher permeability generally provide better productivity rates, whilst membranes having higher selectivity generally provide a hydrogen gas product containing fewer contaminants but at a lower productivity rate. For example, dense metal membranes possess high selectivity for hydrogen over other gases and can be operated at very high temperatures however these membranes have relatively low permeability and are more expensive to manufacture. In contrast, polymeric membranes provide increased permeability and are generally more cost effective but provide lower selectivity with respect to hydrogen. In addition, polymeric membranes typically require lower operation temperatures and have lower chemical stabilities compared to metallic membranes.

Examples of polymeric hydrogen separation membranes include cellulose acetate, polysulfone, polyethersulfone, polyimide and a polyetherimide-based polymeric membranes.

Alternatively, the hydrogen separation membrane may be selected from a metallic-based hydrogen separation membrane. In particular, the hydrogen separation membrane may be selected from a metal organic framework (MOF) comprising at least one transition metal selected from Group VIII, Group IB, Group IIB, Group VIB, Group VIIB, Group IVB and Group VB of the periodic table, magnesium or aluminium and at least one organic ligand. By way of example, the Group VIII transition metal may be selected from Pt, Rh, Ir, Fe, Co and Ni; the Group IB transition metal may be selected from Cu, Ag and Au; the Group IIB transition metal may be selected from Zn and Cd; the Group VIB transition metal may be selected from Cr, Mo and W; the Group VIIB transition metal may be selected from Mn; the Group IVB transition metal may be selected from Ti and Zr; and the Group VB element may be selected from Ta, Nb and V.

Examples of suitable organic ligands for use in forming a metal organic framework membrane include formic acid, MIM (methylimidazole), BIM (benzimidazole), BDC (1,4-dicarboxylic acid benzene), BTC (1,2,4-tricarboxylic acid benzene) 1,4-NDC (1,4-naphthalene dicarboxylic acid), 2,6-NDC (2.6-naphthalene dicarboxylic acid), BBIM (bisbenzimidazole), bpy (4,4′-bipyridine), pym2S2 (dithiopyridine), IN (Isonicotinic acid), pshz (N-propionic salicylhydrazine) or a combination thereof.

In particular, the MOF membrane may comprises at least one metal selected from Zn, Cu, Co, Fe, Cr, Mn, Ti, Zr, Cd, Mg, Al, Ni, Ag, Mo and W and at least one organic ligand is selected from the group consisting of formic acid, MIM (methylimidazole), BIM (benzimidazole), BDC (1,4-dicarboxylic acid benzene), BTC (1,2,4-tricarboxylic acid benzene) 1,4-NDC (1,4-naphthalene dicarboxylic acid), 2,6-NDC (2.6-naphthalene dicarboxylic acid), BBIM (bisbenzimidazole), bpy (4,4′-bipyridine), pym₂S₂ (dithiopyridine), IN (Isonicotinic acid), pshz (N-propionic salicylhydrazine) or a combination thereof.

In particularly preferred examples, the MOF membrane is selected from the group consisting of CuBDC, In(OH)hfipbb, Zn₂(BIM)₄, Zn₂(BIM)₃(OH)(H₂O), Zn(BIM)OAc, Zn₂(MIM)₄(HMIM)(H₂O)₃, CoBDC, Cu(1,4-NDC), Cu(2,6-NDC), or Mn₆(pshz)₆(bpea)₂(dma)₂.

As discussed above, the hydrogen separation membrane may be selected from a metallic membrane comprising a single metal, a metal alloy and/or a metallic complex.

By way of example, the hydrogen separation membrane may comprise a single metal, in particular palladium. Where a palladium membrane is used in step e., the non-condensable light gases are preferably contacted with the membrane at a temperature of at least 300° C. in order to prevent or reduce hydrogen embrittlement of the membrane itself. Hydrogen embrittlement is caused by the transition between the α- and β-phase which occurs when the membrane in contact with hydrogen at temperatures below 300° C. and pressure below 200 Pa. Since the lattice constant of the R-phase is at least 3% larger than that of the α-phase, the nucleation and growth of the β-phase can cause strain within the metal, leading to the formation of cracks or fractures, thereby reducing the selectivity of the membrane.

Optionally, in order to avoid potential temperature limitations and/or reduction of the lifespan of the hydrogen separation membrane due to the embrittlement of the material, the hydrogen separation membrane may be selected from a palladium alloy membrane. The use of an alloy material generally prevents the regular arrangement of hydrogen atoms within the lattice, and so formation of the β-phase does not occur. Palladium alloy membranes are also known to provide increased selectivity to hydrogen gas and greater durability compared with pure palladium membranes.

In embodiments wherein the hydrogen separation membrane is formed from a palladium alloy, the alloy preferably comprises one or more transition metals, in particular the transition metals may be selected from Ag, Au, Ni and Pt.

Optionally, the metallic membrane may comprise a metallic complex comprising one or more ligands. Suitable ligands for use in forming a hydrogen separation membrane include ethylene diamine, diethylene diamine, tetraammonia and diammonia, preferably the one or more ligands are selected from ethylene diamine. In preferred examples, the metallic complex is selected from a palladium complex.

The metallic complex may form an alloy with one or more transition metals. In particular, the one or more transition metals may be selected from Group IB, IVB, VB, VIB, or VIII of the periodic table. By way of example, the one or more Group IB transition metals may be selected from Cu, Ag and Au; the one or more Group IVB transition metals may be selected from Ti or Zr; the one or more Group VB transition metals may be selected from Ta, Nb and V; the one or more Group VIB transition metals may be selected from Cr, Mo and W and/or the one or more Group VIII transition metals are selected from Pt, Rh, Ir, Fe, Co and Ni. Preferably the transition metal is selected from Ni.

Where the hydrogen separation membrane comprises a palladium alloy or a palladium complex, palladium is preferably present in an amount of at least 50% by weight, more preferably in an amount of from 55% to 90% by weight compared to the total weight of the palladium alloy or palladium complex.

The hydrogen separation membrane may be formed as a single layer. Alternatively, the hydrogen separation membrane may be formed as a composite material comprising two or more layers, wherein the layers may be selected from the same or a different material. By way of example, the hydrogen separation membrane may comprise a single layer of palladium or palladium alloy. Alternatively, the membrane may be formed from two or more layers of palladium or palladium alloy, wherein consecutive layers are deposited and/or bonded to the previous layer formed. In general, the or each layer of the palladium alloy membrane comprises a palladium/transition metal alloy alternatively the palladium alloy comprises alternating layers of palladium and one or more transition metals.

Forming the hydrogen separation membrane from a series of connected or bonded layers provides greater control of the thickness of the resulting membrane. This in turn provides greater control of the rate of permeability and the mechanical strength of the membrane formed.

The hydrogen separation membrane may be in the form of an unsupported membrane or a supported membrane.

Unsupported membranes require a greater thickness compared to supported membranes to ensure a sufficient mechanical strength during the hydrogen separation process. However, increasing the thickness of the membrane typically results in lower hydrogen permeability and increased manufacturing costs. Supported membranes are connected to a porous support material, which can lead to a reduction in the required thickness of the palladium/palladium alloy/palladium complex-based membrane layer and thereby a reduction in the overall costs of manufacturing the hydrogen separation membrane. The use of a support material has also been shown to increase the permeability of the membrane without reducing the mechanical strength of the membrane as a whole.

Preferably, the porous support is selected from porous stainless steel, porous ceramic, porous glass or porous nickel, more preferably the support is selected from a porous ceramic material or porous stainless steel. The pore size of the support can affect both the permeability and selectivity of the resulting membrane. In particularly preferred examples, the porous support may comprise pores having a diameter of from 0.5 nm to 5 μm, preferably 0.6 nm to 2 μm. In order to increase selectivity of hydrogen during step e. the support preferably comprises a pore size of from 0.6 nm to 10 nm.

Ceramic supports may be formed from multiple layers of ceramic material, wherein the pore size of each ceramic layer may differ to adjacent ceramic layers. For example, the basic foundation of the ceramic structure may be selected from a macroporous ceramic layer, connected or bonded to mesoporous ceramic layer which in turn is connected or bonded to a microporous ceramic layer on which the hydrogen separation membrane may be deposited. The inclusion of macropores ensures greater permeability through the membrane whereas the microporous surface improves the selectivity of the membrane as a whole and reduces the presence of defects in the palladium/palladium alloy/palladium complex layer deposited thereon.

Stainless steel support materials provide several advantages including i) lower material costs, ii) higher resilience to corrosion and cracking, iii) easier processing, and iv) higher mechanical strength compared to, for example glass and ceramic membranes. However, stainless steel supports often require pre-treatments in order to reduce the pore size of the material and to remove surface defects before a palladium/palladium alloy/palladium complex may be deposited thereon. Preferably, the stainless steel support material is selected from a mesoporous stainless steel support.

A palladium, palladium alloy or palladium complex membrane may be deposited on the surface of a porous support using any suitable process known in this field, for example electroless plating, chemical vapour deposition or sputtering, preferably the palladium or palladium alloy membrane is deposited on the surface of the porous support using electroless plating.

Electroless plating (ELP) provides important advantages in terms of adherence and uniformity of deposits on both conducting and non-conducting surfaces with complex geometries. Additionally, ELP requires lower operational costs compared to other methods of metal deposition.

The palladium, palladium alloy or palladium complex may be deposited directly onto the surface of the support material. In these embodiments, the support material may have undergone one or more pre-treatment steps in order to increase binding of the palladium, palladium alloy or palladium complex or to reduce surface defects within the membrane coating layer.

For example, the pre-treatment steps may comprise chemical pre-treatment step and/or a physical pre-treatment.

As discussed above, such pre-treatment steps are generally applied to metal-based support materials. In contrast, such pre-treatment steps are not commonly used with respect to ceramic supports, due to good original properties in terms of average pore diameter and surface roughness.

Chemical treatments (also referred to as etching) may consist of contacting the support with a corrosive solution, traditionally a strong acid, such as hydrochloric acid or a mixture of hydrochloric acid and nitric acid, for a short period of time. In general, the support is immersed in a strong acid for a time period of from 2 minutes to 10 minutes, preferably for 2.5 minutes to 8 minutes, more preferably from 3 to 7 minutes. Following the chemical treatment, the support is washed with distilled water and allowed to dry at room temperature. Chemical treatment of the support material may be repeated one or more times. As a result of these treatments oxide thin films formed on the surface of support materials are at least partially removed. The removal of the surface oxide layer reduces defects and improves adherence of the subsequent membrane formed thereon.

Physical pre-treatment steps are most commonly used with respect to metal support materials and comprises polishing the external surface of the support. Polishing pre-treatment steps can reduce both external pore size and roughness through mechanical treatment with an abrasive material. Suitable abrasive materials can include for example, commercial sandpapers, such as sandpaper grades #320, #500 and #800.

The supported hydrogen separation membrane may further comprise an intermediate layer between the support material and membrane. The inclusion of an intermediate layer can aid adhesion of a metallic membrane to the surface of a support material and prevent corrosion of the support material. In addition, the intermediate layer may be used to incorporate the first metal nuclei onto the surface of the support to aid deposition of the hydrogen separation membrane, for example when using electroless plating methods. The intermediate layer may be selected from palladium, silver, copper, gold, cerium oxide and or γAl₂O₃, preferably, the intermediate layer is selected from a γAl₂O₃.

The intermediate layer may be applied to the surface of the support using electroless plating, chemical vapour deposition or sputtering.

Alternatively, the hydrogen separation membrane may be bonded to the surface of the porous support via an adhesive or welding or the hydrogen separation membrane may be maintained on the surface of the porous support via mechanical means. For example, the mechanical means may be selected from pins screws, bands, such as an O-ring, rubber ring or fluoro-rubber ring, or a graphite gasket.

The hydrogen separation membrane may comprise any structure suitable for use in separating hydrogen gas from other non-condensable light gases formed during pyrolysis of the low moisture biomass feedstock. For example, the hydrogen separation membrane may be in the form of flat membrane or a tubular membrane, such as a generally straight tubular membrane or a helical tubular membrane.

In general, the hydrogen separation membrane has a thickness of from 0.5 to 25 μm, preferably from 2 to 10 μm, more preferably from 3 to 8 μm. Where the hydrogen separation membrane is an unsupported separation membrane, the membrane may have a thickness of from 25 to 150 μm, preferably from 30 to 100 μm, more preferably from 50 to 75 μm.

The non-condensable light gases formed may be contacted with the hydrogen separation membrane for any suitable time to achieve sufficient separation of hydrogen gas contained therein. In general, the non-condensable light gas may be contacted with the hydrogen separation membrane under atmospheric pressure (including essentially atmospheric conditions). Alternatively, the non-condensable light gases may be contacted with the hydrogen separation membrane at a pressure of 100 to 2000 KPa, preferably 300 to 1500 KPa, more preferably from 500 to 800 KPa in order to produce a purified hydrogen gas stream.

The separated hydrogen gas may be contacted with one or more further hydrogen separation membranes in order to remove further impurities present. The one or more further hydrogen separation membranes may be as defined above. In particular, the one or more further separation membranes may be the same as or selected from a different membrane to the first hydrogen separation membrane. For example, the first membrane may be selected from a high productivity membrane, such as a polymeric hydrogen separation membrane, in order to separate the majority of other non-condensable gases from hydrogen and the second membrane may be selected from a high selectivity membrane, such as a metallic hydrogen separation membrane, in order to further purify the separated hydrogen gas.

Where the non-condensable light gases formed in step c. comprise carbon monoxide, the process may further comprise the step of increasing the hydrogen content of the non-condensable light gas via a water gas shift (WGS) reaction, prior to separating hydrogen gas from the remaining non-condensable light gases (step e.). Alternatively or in addition, following step e. the process may further comprise the step of increasing the hydrogen content of the remaining non-condensable light gases via a water-gas shift reaction.

Preferably carbon monoxide present in the non-condensable light gases or remaining non-condensable light gases is contacted with steam at a temperature of from 250° C. to 450° C. As the WGS reaction is exothermic, carbon monoxide is preferably contacted with steam at a temperature of from 325° C. to 400° C., more preferably at a temperature of from 350° C. to 385° C. in order to increase the yield of bio-derived hydrogen gas.

The water-gas shift reaction comprises at least a stoichiometric ratio of water to carbon monoxide present in the non-condensable light gases or remaining non-condensable light gases. More preferably, excess amounts of water are present with respect to carbon monoxide, for example the ratio of water to carbon monoxide may be from 1 to 5, preferably the ratio of water to carbon monoxide is greater than 1.2, such as from 1.2 to 4.5, more preferably from 1.6 to 3.5.

In some examples, the water gas shift reaction is performed at a pressure of from 0.1 to 2 MPa, preferably from 0.3 to 1.5 MPa, more preferably from 0.5 to 0.8 MPa.

A shift catalyst may also be present in the WGS reaction, wherein the catalyst may be selected from a copper-zinc-aluminium catalyst or a chromium or copper promoted iron-based catalyst. Preferably the catalyst is selected from a copper-zinc-aluminium catalyst. In order to increase contact between carbon monoxide, steam and the selected shift catalyst, and thus improve the efficiency of the WGS reaction, the catalyst may be contained in a fixed bed or trickle bed reactor.

The shift catalyst may undergo a desulphurisation pre-treatment step prior to contact with the non-condensable light gases or remaining non-condensable light gases to remove or reduce sulphur contamination of the resulting bio-derived hydrogen gas formed. Further, sulphur present may, at least partially, deactivate the hydrogen separation membrane, for example sulphur can deactivate palladium-based hydrogen separation membranes. Suitable desulphurisation processes for the shift catalyst will be well known to the person of skill in the art and, of course, the selected treatment may be dependent on the amount of sulphur present in the shift catalyst. By way of example, the desulphurisation pre-treatment step may comprise contacting the shift catalyst with H₂ and H₂O at a temperature of from 300 to 450° C., preferably from 350 to 420° C.

The water gas shift reaction can be applied to the non-condensable gases prior to the step of separating hydrogen gas in order to increase the amount of bio-derived hydrogen gas present. Alternatively, or in addition the water gas shift reaction may be applied to the remaining non-condensable gases following the first and/or one or more further hydrogen gas separating steps. For example, the non-condensable gases or remaining non-condensable gases may be contacted with the shift catalyst at a space velocity of from 500 to 2500 h⁻¹, preferably from 1000 to 2000 h⁻¹.

Where the water gas shift reaction is used to increase the amount of hydrogen present in the remaining non-condensable gases following step e, the hydrogen gas formed may be separated in accordance with any of the hydrogen separation processes defined herein.

Any remaining non-condensable light gases may be at least partially recycled. Preferably, remaining non-condensable light gases may be combined with the biomass feedstock being subjected to pyrolysis (step c.). Thus, remaining non-condensable light gases may be used in the formation of alternative bio-derived fuels.

The process may further comprise the step of at least partially removing sulphur containing components present in the separated non-condensable light gases (step d.) or the hydrogen gas formed in step e. The sulphur containing compounds present in non-condensable light gases or hydrogen gas produced from a biomass feedstock is typically in the form of hydrogen sulphide (H₂S).

Smaller amounts of mercaptans or thiophenes may also be present. Sulphur containing compounds may be removed by contacting the non-condensable light gases or separated hydrogen gas with an amine scrubber or an adsorbent selected from NaOH, FeCl₂, Fe³⁺/MgO, Fe(OH)₃, Fe³⁺/CuSO₄, and Fe³⁺/ethylene diamine tetra-acetic acid (EDTA).

The adsorbent may be contained in a fixed bed or trickle bed reactor to increase contact between the non-condensable light gases/hydrogen gas and the adsorbent to increase the efficiency of the sulphur removing step.

A second embodiment comprises a bio-derived hydrogen gas produced in accordance with the process defined herein.

Preferably, the bio-derived hydrogen has a purity of at least 95%, preferably at least 97% more preferably at least 98.5%.

A third embodiment comprises the use of a bio-derived hydrogen gas, as defined herein, in a fuel cell.

A fourth embodiment comprises the use of a bio-derived hydrogen gas, as defined herein, in petroleum refining processes. In particular, the bio-derived hydrogen gas can be used in one or more of desulphurisation, hydro-treating, hydro-isomerisation and hydrocracking steps used in petroleum refining processes.

A fifth embodiment comprises the use of a bio-derived hydrogen gas, as defined herein, in forming bio-derived ammonia or methane.

The present inventions will now be described with reference to the following non-limiting examples, and with reference to the accompanying drawings, in which:

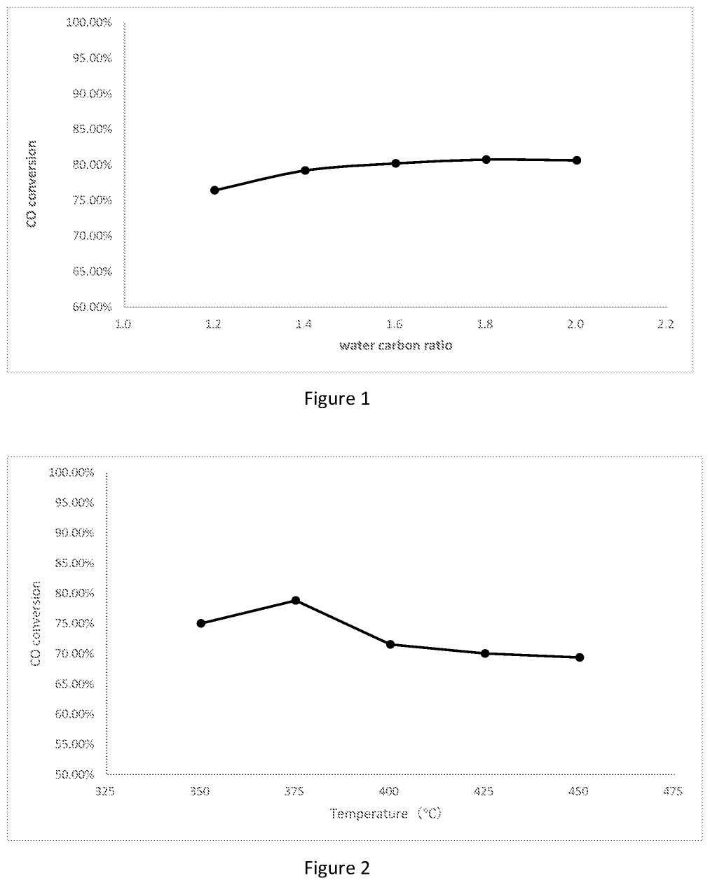

FIG. 1 is a graph illustrating the amount of carbon monoxide converted via a water-gas shift reaction using various ratios of water to carbon monoxide.

FIG. 2 is a graph illustrating the amount of carbon monoxide converted via a water-gas shift reaction at different reaction temperatures.

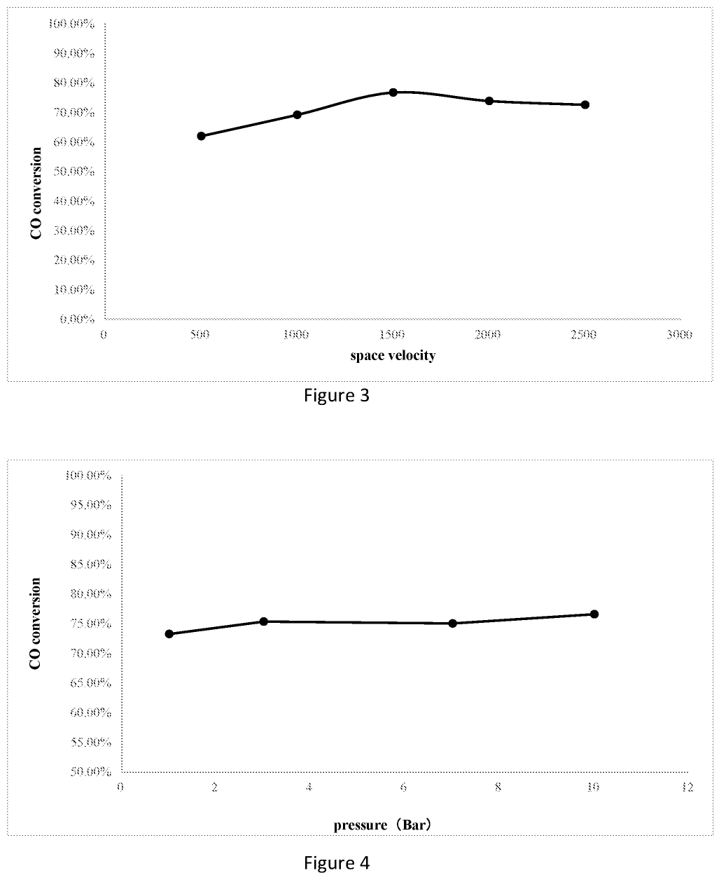

FIG. 3 is a graph illustrating the amount of carbon monoxide converted via a water-gas shift reaction using different flow rates of non-condensable gases.

FIG. 4 is a graph illustrating the amount of carbon monoxide converted via a water gas-shift reaction using different reaction pressures.

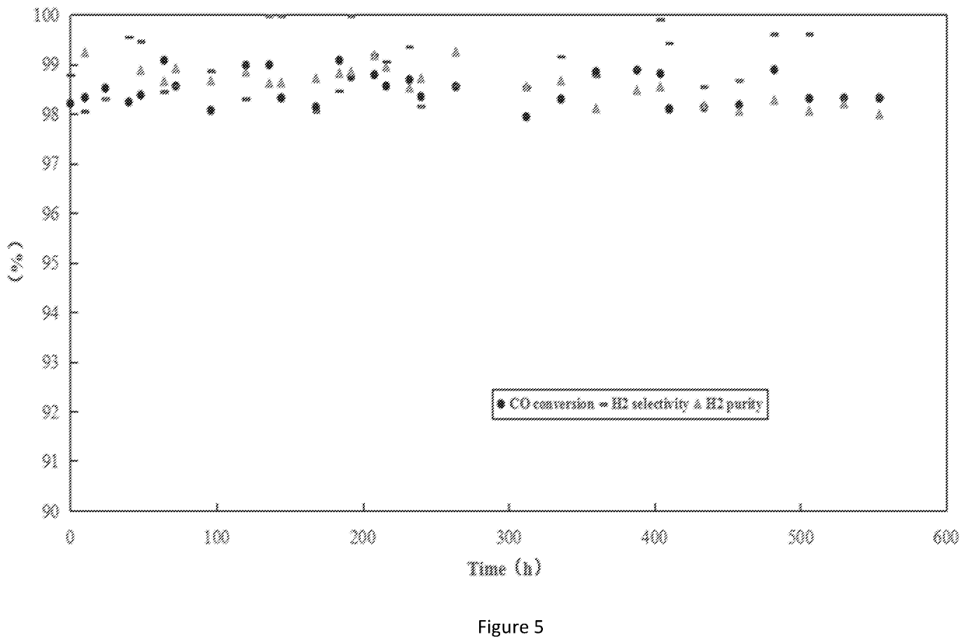

FIG. 5 is a graph illustrating the amount of carbon monoxide converted via a water gas shift reaction, the H₂ selectivity of a palladium membrane and the H₂ purity of a hydrogen gas produced in accordance with the present invention during a steady stage run over a period of 554 hours.

### EXAMPLES

The present examples illustrate the formation and separation of high-purity bio-derived hydrogen gas using a hydrogen separation membrane in combination with a water gas shift reaction step, in accordance with the present invention. As discussed above, the amount of bio-derived hydrogen gas formed is, at least partly, dependent on reaction parameters of the water-gas shift reaction, where performed. Accordingly, the examples provided herein look to optimising the reaction parameters of the hydrogen separation step and water-gas shift reaction to improve both the volume and purity of the hydrogen gas produced.

In each of the examples below the feed gas mixture comprises 40% H₂, 40% CO, 10% CO₂ and 10% CH₄. The shift catalyst used in the examples was purchased from Sichuan Shutai Chemical Technology Co. Ltd. Before use, the shift catalyst underwent a desulphurisation pre-treatment step, wherein the catalyst was contacted with H₂ and H₂O at 400° C.

The hydrogen separation membrane selected for use in the present examples is a palladium membrane on metal support, wherein the palladium membrane has a thickness of around 5 μm and a surface area of 9.4 cm². The hydrogen separation membrane was formed via electroless plating. The permselectivity of the palladium membrane was measured as a H₂/N₂ selectivity ratio of 10900 using a H₂ flux of 109 ml/min at 100 kPa (1 bar) pressure differential at a temperature of 400° C., while the N₂ flux was measured as 0.01 ml/min at 100 kPa (1 bar) pressure differential at temperature of 400° C.

### Example 1—Effect of Varying the Ratio of Water to Carbon Monoxide

A water-gas shift reaction, in accordance with the present invention, was performed using a water to carbon ratio (H₂O:CO) of from 1.2 to 2 in order to determine the effect with respect to carbon monoxide conversion. In each experiment the water-gas shift reaction was performed at a temperature of 400° C., a pressure of 100 KPa (1 bar) and a space velocity of 1500 h⁻¹. As can be observed from FIG. 1, the conversion of carbon monoxide increased from 77% to 81% as the water to carbon ratio increased from 1.2 to 2.

In a second experiment, the water gas shift reaction was performed at a temperature of 375° C., 1500 KPa (15 bar) feed pressure (permeate pressure set as 100 KPa (1 bar)), and a space velocity of 1500 h⁻¹. The water to carbon monoxide ratio was 2.5. The maximum conversion of carbon monoxide was measured as 95.2% and a H₂ selectivity of 96% was observed.

In a third experiment, the water gas shift reaction was performed at a temperature of 375° C., 1500 KPa (15 bar) feed pressure (permeate pressure set as 100 KPa (1 bar)), and a space velocity of 770 h⁻¹. The water to carbon monoxide ratio was varied from 2.5 to 4. It was found that as the ratio of water to carbon monoxide increased, the conversion of carbon monoxide also increased from 96.03% to 98.21%.

### Example 2—Effect of Varying the Operating Temperature

A water-gas shift reaction was performed using various operating temperatures within the range of from 350° C. to 450° C. For each experiment, the reaction pressure was 100 KPa (1 bar) and a space velocity of 1500 h⁻¹. In addition, a water to carbon monoxide ratio of 1.2 was used in each of the experiments. FIG. 2 shows that the conversion of carbon monoxide increases as the operating temperature increases from 350° C. to 375° C. However, subsequent increases in temperature result in reduced amount of carbon monoxide being converted. Without wishing to be bound by any particular theory, one hypothesis is that the observed decrease in the conversion of carbon monoxide at higher reaction temperatures is due to the exothermic nature of the water-gas shift reaction, as discussed above.

### Example 3—Effect of Varying the Space Velocity of the Non-Condensable Gas

The effect of varying the space velocity of the non-condensable gases was studied between 500 to 250 h⁻¹. In these experiments the water-gas shift reaction was maintained at a temperature of 400° C. A pressure of 100 KPa (1 bar) and a water to carbon monoxide ratio of 1.2 was used in each of the experiments. As can be observed from FIG. 3, the conversion of carbon monoxide increases from 500 to 1500 h⁻¹, with a maximum conversion observed at 1500 h¹. A slight decrease in the conversion of carbon monoxide was observed following further increases in the space velocity of the non-condensable gases. Without being bound by any theory, it is considered that the initial increasing levels of conversion observed is due to the generation of heat from the exothermic water-gas shift reaction.

### Example 4—Effect of Varying the Reaction Pressure

The effect of varying the reaction pressure of the water-gas shift reaction was determined for reaction pressures of from 100 to 1,000 KPa (1 to 10 bar). In these experiments the temperature of the water-gas shift reaction was maintained at 400° C. A water to carbon monoxide ratio of 1.2 was used along with a space velocity of 1500 h⁻¹ in each of the experiments. As can be observed from FIG. 4, the conversion of carbon monoxide was approximately consistent at around 75% in each of these experiments, indicating that the pressure selected had little effect on the resulting conversion.

### Example 5—Durability of the Palladium Membrane and Water-Gas Shift Reaction

The durability of both the palladium membrane and the water-gas shift reaction catalyst was analysed periodically based on the conversion of carbon monoxide, H₂ selectivity and H₂ purity during a steady stage run of the reaction. The water-gas shift reaction catalyst and palladium membrane were contained in the same reaction vessel and the water-gas shift reaction was performed at a temperature of 375° C., a feed pressure of 1500 KPa (15 bar) (permeate pressure set as 100 KPa (1 bar)), and a space velocity of 770 h⁻¹. The water to carbon monoxide ratio was 4.

As shown in FIG. 5 the conversion of carbon monoxide, H₂ selectivity and H₂ purity were each greater than 98% at the end of 554 hours. Table 1 further illustrates a selection of the data provided in FIG. 5. In addition, no deactivation or degradation of either the shift catalyst or membrane was observed after 554 hours, demonstrating the robust nature of the technology.

TABLE 1

| Reaction | Conversion | H₂ | H₂ |
|---|---|---|---|
| Time (Hours) | of CO (%) | Selectivity (%) | Purity (%) |
| 40 | 98.38 | 99.46 | 98.86 |
| 72 | 98.56 | 98.57 | 98.90 |
| 120 | 98.98 | 97.72 | 98.83 |
| 168 | 98.14 | 98.06 | 98.69 |
| 216 | 98.56 | 99.06 | 98.92 |
| 336 | 98.30 | 99.16 | 98.67 |
| 434 | 98.13 | 98.55 | 98.17 |
| 530 | 98.32 | 98.34 | 98.21 |

1. A process for forming a bio-derived hydrogen gas from a biomass feedstock, comprising the steps of:
a. providing a biomass feedstock;
b. ensuring the moisture content of the biomass feedstock is 10% or less by weight of the biomass feedstock;
c. pyrolysing the low moisture biomass feedstock at a temperature of at least 950° C. to form a mixture of biochar, hydrocarbon feedstock, non-condensable light gases, such as hydrogen, carbon monoxide, carbon dioxide and methane, and water;
d. separating the non-condensable light gases from the mixture formed in step c.;
e. separating hydrogen gas from the remaining non-condensable light gases using a hydrogen separation membrane.

2. A process according to claim 1, wherein the biomass feedstock comprises cellulose, hemicellulose or lignin-based feedstocks.

3. A process according to claim 1 or claim 2, wherein the biomass feedstock is a non-food crop biomass feedstock, preferably the non-crop biomass feedstock is selected from miscanthus, switchgrass, garden trimmings, straw, such as rice straw or wheat straw, cotton gin trash, municipal solid waste, palm fronds/empty fruit bunches (EFB), palm kernel shells, bagasse, wood, such as hickory, pine bark, Virginia pine, red oak, white oak, spruce, poplar, and cedar, grass hay, mesquite, wood flour, nylon, lint, bamboo, paper, corn stover, or a combination thereof.

4. A process according to any one of claims 1 to 3, wherein the biomass feedstock is in the form of pellets, chips, particulates or a powder, preferably the pellets, chips, particulates or powder have a diameter of from 5 μm to 10 cm, such as from 5 μm to 25 mm, preferably from 50 μm to 18 mm, more preferably from 100 μm to 10 mm.

5. A process according to claim 4, wherein the pellets, chips, particulates or powder have a diameter of at least 1 mm, such as from 1 mm to 25 mm, 1 mm to 18 mm or 1 mm to 10 mm.

6. A process according to any preceding claim, wherein initial moisture content of the biomass feedstock is up to 50% by weight of the biomass feedstock, such as up to 45% by weight of the biomass feed stock, or for example up to 30% by weight of the biomass feedstock.

7. A process according to any preceding claim, wherein the moisture content of the biomass feedstock is reduced to 7% or less by weight, such as 5% or less by weight of the biomass feedstock.

8. A process according to any preceding claim, wherein the step of ensuring the moisture content of the biomass feedstock is 10% or less by weight of the biomass feedstock comprises reducing the moisture content of the biomass feedstock.

9. A process according to claim 8 wherein the moisture content of the biomass feedstock is reduced by use of a vacuum oven, a rotary dryer, a flash dryer or a heat exchanger, such as a continuous belt dryer, preferably wherein the moisture content of the biomass feedstock is reduced through the use of indirect heating, for example by using an indirect heat belt dryer, an indirect heat fluidised bed or an indirect heat contact rotary steam-tube dryer.

10. A process according to any preceding claim, wherein the low moisture biomass feedstock is pyrolysed at temperature of at least 1000° C., more preferably at a temperature of at least 1100° C.

11. A process according to any preceding claim, wherein heat is provided to the pyrolysis step by means of convection heating, microwave heating, electrical heating or supercritical heating.

12. A process according to claim 11, wherein the heat source comprises microwave assisted heating, a heating jacket, a solid heat carrier, a tube furnace or an electric heater, preferably the heating source is a tube furnace.

13. A process according to claim 11, wherein the heat source is positioned inside the reactor, preferably the heat source comprises one or more electric spiral heaters, such as a plurality of electric spiral heaters.

14. A process according to any preceding claim, wherein the low moisture biomass is pyrolysed at atmospheric pressure or the low moisture biomass is pyrolysed under a pressure of from 850 to 1000 Pa, preferably from 900 to 950 Pa and, optionally, wherein the pyrolysis gases formed are separated through distillation.

15. A process according to any preceding claim, wherein the low moisture biomass feedstock is pyrolysed for a period of from 10 seconds to 2 hours, preferably, from 30 seconds to 1 hour, more preferably from 60 seconds to 30 minutes, such as 100 seconds to 10 minutes.

16. A process according to any preceding claim, wherein the pyrolysis reactor is arranged such that the low moisture biomass is conveyed in a counter-current direction to any pyrolysis gases formed, and optionally wherein biochar formed as a result of the pyrolysis step leaves pyrolysis reactor separate to the pyrolysis gases.

17. A process according to claim 16, wherein the pyrolysis gases are subsequently cooled, for example through the use of a venturi, to condense the hydrocarbon feedstock product.

18. A process according to any preceding claim, wherein step d. comprises at least partially separating the non-condensable light gases from the mixture formed in step c. by use of flash distillation or fractional distillation.

19. A process according to any preceding claim, wherein the hydrogen separation membrane is selected from a polymeric membrane, a metal organic framework (MOF) or a metallic membrane.

20. A process according to claim 19, wherein the metallic membrane comprises a single metal, a metal alloy and/or a metallic complex.

21. A process according to claim 19, wherein the polymeric membrane is selected from the group consisting of cellulose acetate, polysulfone, polyethersulfone, polyimide or a polyetherimide-based polymeric membrane.

22. A process according to claim 19, wherein the MOF membrane comprises a metal selected from Zn, Cu, Co, Fe, Cr, Mn, Ti, Zr, Cd, Mg, Al, Ni, Ag, Mo and W and at least one organic ligand selected from the group consisting of formic acid, MIM (methylimidazole), BIM (benzimidazole), BDC (1,4-dicarboxylic acid benzene), BTC (1,2,4-tricarboxylic acid benzene) 1,4-NDC (1,4-naphthalene dicarboxylic acid), 2,6-NDC (2.6-naphthalene dicarboxylic acid), BBIM (bisbenzimidazole), bpy (4,4′-bipyridine), pym₂S₂(dithiopyridine), IN (Isonicotinic acid), pshz (N-propionic salicylhydrazine) or a combination thereof.

23. A process according to claim 22, wherein the MOF membrane is selected from the group consisting of CuBDC, In(OH)hfipbb, Zn₂(BIM)₄, Zn₂(BIM)₃(OH)(H₂O), Zn(BIM)OAc, Zn₂(MIM)₄(HMIM)(H₂O)₃, CoBDC, Cu(1,4-NDC), Cu(2,6-NDC), or Mn₆(pshz)₆(bpea)₂(dma)₂.

24. A process according to claim 20, wherein the metallic membrane is selected from palladium or a palladium alloy.

25. A process according to claim 24, wherein the palladium alloy comprises one or more transition metals selected from Ag, Au, Ni and Pt.

26. A process according to claim 20, wherein the metallic membrane comprises a palladium complex comprising one or more ligands, preferably the one or more ligands are selected from ethylene diamine, diethylene diamine, tetraammonia and diammonia.

27. A process according to claim 26, wherein the palladium complex is in the form of an alloy with one or more transition metals.

28. A process according to claim 27, wherein the one or more transition metals are selected from Group IB, IVB, VB, VIB, or VIII of the periodic table.

29. A process according to claim 28, wherein the one or more transition metals are selected from Group IB of the periodic table, preferably the one or more transition metals are selected from Cu, Ag and Au.

30. A process according to claim 28, wherein the one or more transition metals are selected from Group IVB of the periodic table, preferably the one or more transition metals are selected from Ti or Zr.

31. A process according to claim 28, wherein the one or more transition metals are selected from Group VB of the period table, preferably the one or more transition metals are selected from Ta, Nb and V.

32. A process according to claim 28, wherein the one or more transition metals are selected from Group VIB of the periodic table, preferably the one or more transition metals are selected from Cr, Mo and W.

33. A process according to claim 28, wherein the one or more transition metals are selected from Group VIII of the periodic table, preferably the one or more transition metals are selected from Pt, Rh, Ir, Fe, Co and Ni, more preferably the transition metal is selected from Ni.

34. A process according to any one of claims 24 to 33, wherein the palladium alloy or palladium complex comprises palladium in an amount of at least 50% by weight, preferably in an amount of from 55% to 90% by weight based on the total weight of the palladium alloy or palladium complex.

35. A process according to any one of claims 24 to 34, wherein the metallic membrane is formed from two or more layers of palladium, palladium alloy or a palladium complex.

36. A process according to claim 35, wherein the metallic membrane is selected from a palladium alloy and wherein each layer comprises a palladium/transition metal alloy or wherein the palladium alloy comprises alternating layers of palladium and one or more transition metals.

37. A process according to any preceding claim, wherein the hydrogen separation membrane further comprises a porous support, preferably the porous support is selected from porous stainless steel, porous ceramic, porous glass or porous nickel, more preferably the support is selected from a porous ceramic material or porous stainless steel.

38. A process according to claim 37, wherein the pores of the porous support have a diameter of from 0.5 nm to 5 μm, preferably 0.6 nm to 2 μm, more preferably from 0.6 nm to 10 nm.

39. A process according to any preceding claim, wherein the hydrogen separation membrane is in the form of flat membrane or a tubular membrane, such as a generally straight tubular membrane or a helical tubular membrane.

40. A process according to any one of claims 24 to 39, wherein the palladium, palladium alloy or palladium complex membrane has been applied to the surface of the porous support using electroless plating, chemical vapour deposition or sputtering, preferably the palladium, palladium alloy or palladium complex membrane has been applied to the surface of the porous support using electroless plating.

41. A process according to any one of claims 37 to 39, wherein the hydrogen separation membrane is bonded to the surface of the porous support via an adhesive or welding or the hydrogen separation membrane is maintained on the surface of the porous support via mechanical means.

42. A process according to claim 41, wherein the mechanical means are selected from pins screws, bands, such as an O-ring, rubber ring or fluoro-rubber ring, or a graphite gasket.

43. A process according to any preceding claim wherein the hydrogen separation membrane has a thickness of from 0.5 to 25 μm, preferably from 2 to 10 μm, more preferably from 3 to 8 μm.

44. A process according to any one of claims 37 to 43, wherein the supported hydrogen separation membrane further comprises an intermediate layer positioned between the support and the hydrogen separation membrane, preferably the intermediate layer is selected from palladium, silver, copper, gold, cerium oxide and or γAl₂O₃, more preferably, the intermediate layer is selected from γAl₂O₃.

45. A process according to claim 44, wherein the intermediate layer is applied to the surface of the support using electroless plating, chemical vapour deposition or sputtering.

46. A process according to any preceding claim, wherein the non-condensable light gases are contacted with the hydrogen separation membrane at ambient pressure or under a pressure of from 100 KPa to 2000 KPa, preferably from 300 KPa to 1500 KPa, more preferably from 500 KPa to 800 KPa.

47. A process according to any preceding claim, wherein the separated hydrogen gas is contacted with a second hydrogen separation membrane, in order to remove further impurities from the separated hydrogen gas.

48. A process according to claim 47, wherein the second hydrogen separation membrane is as defined in any one of claims 19 to 45.

49. A process according to any preceding claim, further comprising the step of increasing the hydrogen content of the non-condensable light gases through a water gas shift reaction before separating hydrogen gas from the remaining non-condensable light gases.

50. A process according to any preceding claim, further comprising the step of increasing the hydrogen content of the remaining non-condensable light gases through a water gas shift reaction following step e.

51. A process according to claim 50, wherein the hydrogen formed is separated from the remaining the non-condensable light gases in accordance with any one of claims 19 to 48.

52. A process according to any one of claims 49 to 51, wherein the ratio of water to carbon monoxide of the non-condensable gas or remaining non-condensable gas is from 1 to 5, preferably the ratio of water to carbon monoxide is greater than 1.2, such as from 1.2 to 4.5, preferably from 1.6 to 3.5.

53. A process according to any one of claims 49 to 52, wherein the water gas shift reaction is performed at a temperature of from 250° C. to 450° C., preferably a temperature of from 325° C. to 400° C., more preferably from 350 to 385° C.

54. A process according to any one of claims 49 to 53, wherein the water gas shift reaction is performed at a pressure of from 0.1 to 2 MPa, preferably from 0.3 to 1.5 MPa.

55. A process according to any one of claims 49 to 54, wherein the water-gas shift reaction further comprises a shift catalyst, preferably the shift catalyst is selected from a copper-zinc-aluminium catalyst or a chromium or copper promoted iron-based catalyst, more preferably the shift catalyst is a copper-zinc-aluminium catalyst.

56. A process according to any preceding claim, wherein the remaining non-condensable light gases are at least partially recycled and optionally combined with the low moisture biomass feedstock in step c.

57. A bio-derived hydrogen gas formed by the process defined in any one of claims 1 to 54.

58. A bio-derived hydrogen gas according to claim 57, wherein the hydrogen gas has a purity of at least 95%, preferably at least 97% more preferably at least 98.5%,

59. Use of a bio-derived hydrogen gas as defined in claim 57 or 58 in fuel cells.

60. Use of a bio-derived hydrogen gas as defined in claim 57 or 58, in petroleum refining processes.

61. Use of a bio-derived hydrogen gas as defined in claim 57 or 58, in forming bio-derived ammonia or methane.
